(19) United States
(12) Patent Application Publication
(10) Pub. No.: US 2025/0272537 A1
(43) Pub. Date: Aug. 28, 2025

(54) RUNTIME SHARING OF MULTIPLE NEURAL NETWORK MODELS IN A COMPUTING SYSTEM

(71) Applicant: International Business Machines Corporation, Armonk, NY (US)

(72) Inventors: Ka Ho Chow, San Jose, CA (US); Umesh Deshpande, San Jose, CA (US); Swaminathan Sundararaman, San Jose, CA (US)

(21) Appl. No.: 18/588,093

(22) Filed: Feb. 27, 2024

(51) Int. Cl. G06N 3/045; G06N 3/10

(52) U.S. Cl. CPC G06N 3/045; G06N 3/10

(57) ABSTRACT

Computer-implemented methods for runtime sharing of multiple neural network models in a computing system are provided. Aspects include receiving a request to store first neural network model (NNM) in the computing system, obtaining parameters of the first NNM, and identifying a base model, from a model database, corresponding to the first NNM. Aspects also include identifying duplicate parameters of the first NNM and the base model and generating a delta file corresponding to non-duplicate parameters of the first NNM and the base model. Aspects further include identifying a physical memory device in the computing system that includes a shared region that includes at least a portion of the base model and loading, in a private region of the physical memory device, the parameters from the delta file.

### BACKGROUND

The present disclosure generally relates to the use of neural network models, and more specifically, to runtime sharing of multiple neural network models in a computing system.

Recently, the usage of neural network models, often generally referred to as machine learning models, has drastically increased. In general, a neural network model is organized into layers, consisting of interconnected nodes or neurons. The input layer receives and processes data, passing it through hidden layers that perform complex computations using weighted connections. The final output layer produces the model's predictions, and during training, the network adjusts the weights through backpropagation to optimize its ability to learn and generalize from the input data.

Neural network models are very large and require immense data sets and vast amounts of computing resources to train. As a result, most of the neural network models that are deployed are variants of a few base models such as Llama-2, T5, ResNet, VGG, and the like. Variants of neural network models that have been finetuned on the same base model often share a large number of common parameters (e.g., >99%). Currently, despite the commonality of the parameters, variants of neural network models are each deployed in separate containers of a computing system, where each container has one or more dedicated Graphics Processing Units (GPUs). The entire model, e.g., all of the layers of the neural network model, are then loaded into their respective GPUs.

### SUMMARY

Embodiments of the present disclosure are directed to computer-implemented methods for runtime sharing of multiple neural network models in a computing system. According to an aspect, a computer-implemented method includes receiving a request to store first neural network model (NNM) in the computing system, obtaining parameters of the first NNM, and identifying a base model, from a model database, corresponding to the first NNM. The method also includes identifying duplicate parameters of the first NNM and the base model and generating a delta file corresponding to non-duplicate parameters of the first NNM and the base model. The method further includes identifying a physical memory device in the computing system that includes a shared region that includes at least a portion of the base model and loading, in a private region of the physical memory device, the parameters from the delta file.

Embodiments also include computing systems and computer program products for runtime sharing of multiple neural network models in a computing system.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for runtime sharing of multiple neural network models in a computing system in accordance with one or more embodiments of the present disclosure;

FIG. 3 depicts a block diagram of a compute node of a computing system that is configured to serve multiple neural network models in accordance with one or more embodiments of the present disclosure;

FIG. 4 depicts a flowchart of a method for runtime sharing of multiple neural network models in a computing system in accordance with one or more embodiments of the present disclosure;

FIG. 5 depicts a flowchart of a method for runtime sharing of a neural network model in a computing system in accordance with one or more embodiments of the present disclosure; and

FIG. 6 depicts a flowchart of a method for executing a neural network model in a computing system in accordance with one or more embodiments of the present disclosure.

### DETAILED DESCRIPTION

Embodiments include a computer-implemented method for runtime sharing of multiple neural network models in a computing system. The method includes receiving a request to store first neural network model (NNM) in the computing system, obtaining parameters of the first NNM, and identifying a base model, from a model database, corresponding to the first NNM. The method also includes identifying duplicate parameters of the first NNM and the base model and generating a delta file corresponding to non-duplicate parameters of the first NNM and the base model. The method further includes identifying a physical memory device in the computing system that includes a shared region that includes at least a portion of the base model and loading, in a private region of the physical memory device, the parameters from the delta file. Technical benefits of the computer-implemented method include improving the efficiency of the computing system by only storing a single copy of duplicate parameters of different versions of neural network models.

In addition to the one or more features described herein the physical memory device is a graphical processing unit.

In addition to the one or more features described herein the method also includes creating a logical memory corresponding to the first NNM, the logical memory including pointers to the shared region of the physical memory device having parameters of the base model and a pointer to the delta file that is stored in the private region of the physical memory device.

In addition to the one or more features described herein the delta file includes one or more layers of the first NNM that are not identical to layers of the base model.

In addition to the one or more features described herein the delta file includes a difference value for each of the parameters of the first NNM and the base model.

In addition to the one or more features described herein the base model is identified at least based in part on calculating a similarity score of an architecture of the first NNM and the architecture of a plurality of NNMs in the model database.

In addition to the one or more features described herein based on a determination that the model database does not include a NNM having at least a minimum threshold similarity score with the first NNM, the method also includes adding the first NNM to the model database and storing the parameters of the first NNM in a shared region of a first physical memory device in the computing system.

Embodiments include a computing system having a memory having computer readable instructions and one or more processors for executing the computer readable instructions, the computer readable instructions controlling the one or more processors to perform operations. The operations include receiving a request to store first neural network model (NNM) in the computing system, obtaining parameters of the first NNM, and identifying a base model, from a model database, corresponding to the first NNM. The operations also include identifying duplicate parameters of the first NNM and the base model and generating a delta file corresponding to non-duplicate parameters of the first NNM and the base model. The operations further include identifying a physical memory device in the computing system that includes a shared region that includes at least a portion of the base model and loading, in a private region of the physical memory device, the parameters from the delta file. Technical benefits of the computer-implemented method include improving the efficiency of the computing system by only storing a single copy of duplicate parameters of different versions of neural network models.

Embodiments further include a computer program product comprising a computer readable storage medium having program instructions embodied therewith, the program instructions executable by a processor to cause the processor to perform operations. The operations include receiving a request to store first neural network model (NNM) in the computing system, obtaining parameters of the first NNM, and identifying a base model, from a model database, corresponding to the first NNM. The operations also include identifying duplicate parameters of the first NNM and the base model and generating a delta file corresponding to non-duplicate parameters of the first NNM and the base model. The operations further include identifying a physical memory device in the computing system that includes a shared region that includes at least a portion of the base model and loading, in a private region of the physical memory device, the parameters from the delta file. Technical benefits of the computer-implemented method include improving the efficiency of the computing system by only storing a single copy of duplicate parameters of different versions of neural network models.

As discussed in more detail above, variants of neural network models that are deployed in a computing system are each deployed in separate containers that each have one or more dedicated GPUs. The entire neural network model, e.g., all of the layers of the neural network model, are then loaded into their respective GPUs. As a result, multiple copies of common layers of variants of a single base neural network model are often saved in several GPUs in a computing system. Currently, there is no method or system for sharing GPU resources among multiple containers of a computing system while also providing isolation between the containers.

In exemplary embodiments, systems and methods for serving multiple neural network models in a computing system are provided. As will be appreciated by those of ordinary skill in the art, the multiple neural network models may be disposed in a Cloud computing system or in an on-premises computing system. In exemplary embodiments, compute nodes of the computing system each include GPUs that have a physical memory and one or more containers that have a logical memory. In exemplary embodiments, the physical memory of the GPUs is divided into a shared region and into private regions, which each correspond to containers deployed on the compute node. The logical memory of the containers includes pointers to both the shared region and the private regions of the physical memory of the GPUs.

In exemplary embodiments, the computing system is configured to serve each neural network model in a separate container, and for the containers corresponding to neural network models having a common base model to share one or more GPUs. The neural network models that are served in the computing system are analyzed to identify models that have a common base model and to identify duplicate portions of the neural network models. The duplicate portions of the model are stored in the shared region of the GPU memory and unique portions of the model are stored in the corresponding private regions of the GPU memory. As a result, GPU resources are more effectively utilized by not storing duplicate copies of common portions of multiple neural network models.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as runtime sharing of multiple neural network models in a computing system at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

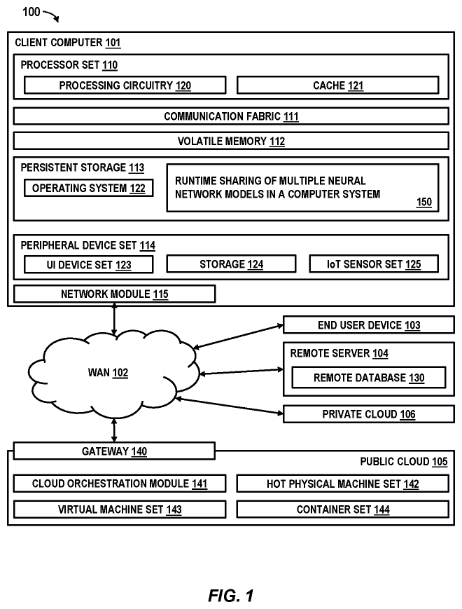

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community, or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

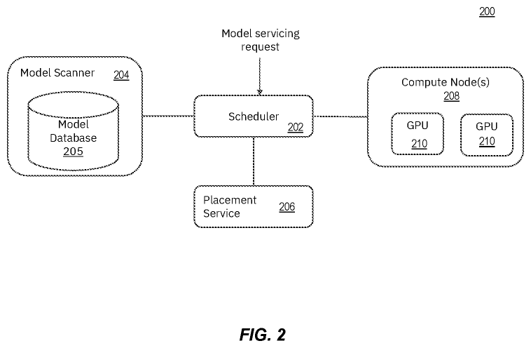

Referring now to FIG. 2, a block diagram of a system 200 for storing multiple neural network models in a computing system in accordance with one or more embodiments of the present disclosure is shown. In exemplary embodiments, the system 200 is embodied in a computing environment 100, such as the one shown in FIG. 1. The system 200 includes a scheduler 202, a model scanner 204, a placement service 206, and one or more compute nodes 208.

In exemplary embodiments, the scheduler 202 is configured to receive a request to serve a neural network model on a computing system. In one embodiment, the scheduler 202 is configured to provide the requested neural network model to a model scanner 204 that is configured to analyze the neural network model. For example, the model scanner 204 may analyze the neural network model to identify an architecture of the neural network model and to identify the layers or parameters of the neural network model. The model scanner 204 is also configured to compare the neural network model to entries in the model database 205.

In exemplary embodiments, each entry in the model database 205 corresponds to a neural network model that has been deployed on the computing system. The model database 205 may store base models, variants of base models, or other neural network models that have been deployed in the computing system. In one embodiment, a base neural network model is a neural network model that may be publicly available, such as Llama-2, T5, ResNet, VGG, and the like. In exemplary embodiments, the model scanner 204 is configured to determine whether the neural network model received from the scheduler 202 corresponds to one of the entries in the model database 205, i.e., whether the neural network model is a variant of another neural network model that is deployed in the computing system.

In one example, for models created using parameter-efficient fine-tuning (PEFT), the model scanner 204 identifies the duplicate tensors between the neural network model and the identified base model. PEFT is a technique used to improve the performance of neural network models on specific downstream tasks that involves reusing a pre-trained model's parameters and fine-tuning them on a smaller dataset, which saves computational resources and time compared to training the entire model from scratch. PEFT achieves this efficiency by freezing some of the layers of the pre-trained model and only fine-tuning a few layers that are specific to the downstream task. As a result, the pre-trained model can be adapted to new tasks with less computational overhead and fewer labeled examples.

In another example, models created using fine-tuning, the model scanner 204 identifies the difference between parameter values of the neural network model and an identified variant, the differences are then saved as a delta file. In general, fine-tuning includes taking a pre-trained model and training it further on a new task with new data. The entire pre-trained model is usually retrained in fine-tuning, including all its layers and parameters. Fine-tuning process can be computationally expensive and time-consuming, especially for large models.

In exemplary embodiments, based on the determination of whether the neural network model is a variant of another neural network model that is deployed in the computing system, the placement service 206 is configured to identify a location for serving the neural network model in the computing system. In exemplary embodiments, the placement service 206 is configured to select a location, i.e., a compute node 208, to maximize the sharing of GPUs 210 by different variants of neural network models in the computing system. In one embodiment, the scheduler 202 is configured to consult the model scanner 204 to identify the resource requirement for hosting a neural network model. The resource requirement depends on the model's size (i.e., size difference with respect to already served models) and GPU consumption (pre-calculated through profiling).

In exemplary embodiments, based on information received from the model scanner 204 and the placement service 206, the scheduler 202 is configured to serve the neural network model in a container on a compute node and to notify the placement service 206 of the location of the neural network model. The model placement service 206 records the location of the newly launched instance for use in the placement of other neural network models.

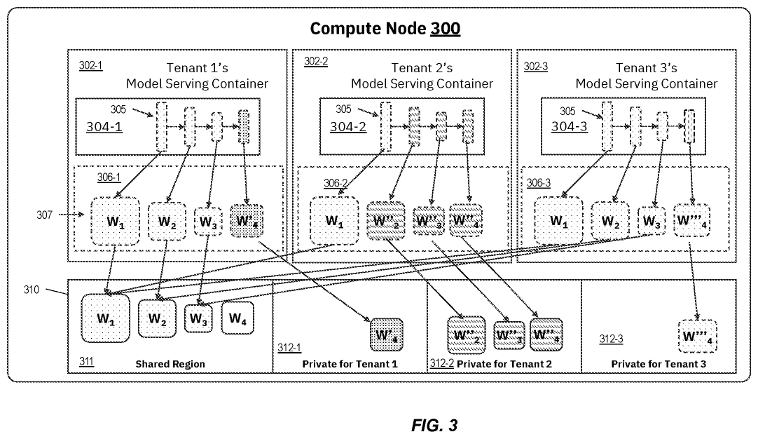

Referring now to FIG. 3, a block diagram of a compute node 300 of a computing system that is configured to serve multiple neural network models in accordance with one or more embodiments of the present disclosure is shown. The compute node 300 also includes software and hardware that are used to execute the workload on the compute node. In exemplary embodiments, the hardware includes one or more processors, a memory, and one or more Peripheral Component Interconnect (PCI) devices. The software includes a Cloud platform (such as Amazon Webservices (AWS), AZURA, IBM Cloud, or the like), a container management system (such as Kubernetes or OpenShift), an operating system, and an identification of a virtualization technology (such as KVM, Hyper-V, VMWARE) being used in the compute node 300. In exemplary embodiments, the compute node 300 includes a graphical processing unit (GPU) that has a physical memory 310. The physical memory 310 of the GPU is divided into a shared region 311 and into one or more private regions 312-1, 312-2, 312-3, referred to collectively as private regions 312.

In exemplary embodiments, the compute node 300 includes a plurality of containers 302-1, 302-2, 302-3, referred to collectively as containers 302. Each of the containers 302 are configured to serve a respective neural network model 304-1, 304-2, 304-3, referred to collectively as models 304. As illustrated, the models 304 each include several layers 305, which may be the same or different from the layers 305 of the other models 304 on the compute node 300. Each of the containers 302 also includes a corresponding logical memory 306-1, 306-2, 306-3, referred to collectively as corresponding logical memory 306.

In exemplary embodiments, the logical memory 306 of a container 302 is configured to store pointers 307 that corresponds to each of the layers 305 of a model 304 deployed on the container 302. Each of the pointers 307 corresponds to locations in the physical memory 310 of the GPU. Common portions or layers 305 of the model 304 are stored in a shared region 311 of the physical memory 310 of the GPU. Unique portions or layers 305 of the model 304 are stored in a private region 311 of the physical memory 310 of the GPU that corresponds to a respective container 302.

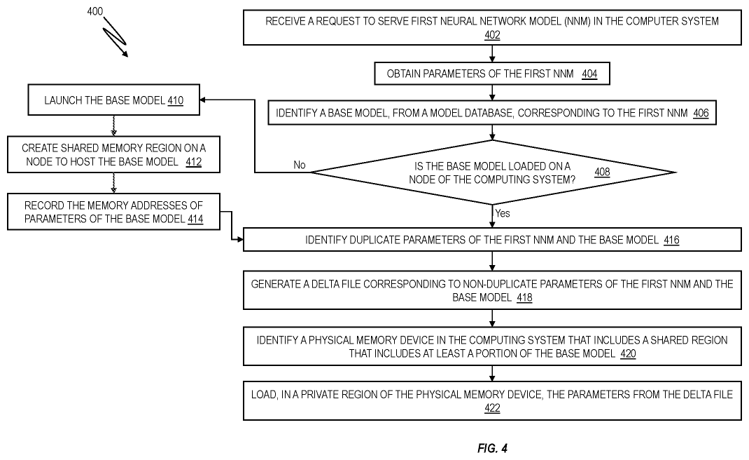

Referring now to FIG. 4, a flowchart of a method 400 for runtime sharing of multiple neural network models in a computing system in accordance with one or more embodiments of the present disclosure is shown. As used herein the term computing system may refer to on on-premises computing system or to a Cloud computing system that may include a public Cloud, a private could, and a combination of the two. In exemplary embodiments, the method 400 is performed by a scheduler 202, such as the one shown in FIG. 2.

As shown at block 402, the method 400 includes receiving a request to serve the first neural network model (NNM) in the computing system. Next, as shown at block 404, the method 400 includes obtaining parameters of the first NNM. The method 400 also includes identifying a base model, from a model database, corresponding to the first NNM, as shown at block 406. In one embodiment, the base model is identified at least based in part on a comparison of the parameters of the first NNM and the parameters of the models stored in the model database.

In one embodiment, an architecture of the first NNM is obtained in addition to the parameters of the first NNM. The architecture of the first NNM may be used to identify a base model that corresponds to the first NNM from the model database by comparing the architecture of a plurality of NNMs in the model database to the architecture of the first NNM. In one embodiment, a similarity score between the first NNM and each of the plurality of models in the model database is calculated using a graph similarity scoring system to calculate a similarity between the architecture of the first NNM and the architecture of the plurality of NNMs in the model database.

Next, as shown at decision block 408, the method 400 includes determining whether the base model has been loaded on a node of a computing system (i.e., does a GPU of a compute node include the base model). If the base model has been loaded on a node of a computing system, the method 400 proceeds to block 416. If the base model has not been loaded on a node of a computing system, the method 400 proceeds to block 410 and launches the base model. Next, as shown at block 412, the method 400 includes creating a shared memory region on a compute node of the computing system to host the base model. The method 400 also includes recording the memory addresses of the parameters of the base model in the model database, as shown at block 414.

Next, as shown at block 416, the method 400 includes identifying duplicate parameters of the first NNM and the base model. In one embodiment, the duplicate parameters may include one or more common layers of the first NNM and the base model. The method 400 also includes generating a delta file corresponding to non-duplicate parameters of the first NNM and the base model, as shown at block 418. In one embodiment, the delta file includes one or more layers of the first NNM that are not identical to layers of the base model. In another embodiment, the delta file includes a difference value for each of the parameters of the first NNM and the base model. For example, for a fine-tuned variant of a base model, the delta file may include a difference value for each of the parameters of the first NNM and the base model.

As shown at block 420, the method 400 includes identifying a physical memory device in the computing system that includes a shared region that includes at least a portion of the base model. Next, as shown at block 422, the method 400 includes loading, in a private region of the physical memory device, the parameters from the delta file. In exemplary embodiments, the physical memory device is a graphical processing unit that is disposed on a compute node in the computing system. In exemplary embodiments, the method 400 also includes creating a logical memory corresponding to the first NNM, the logical memory including pointers to the shared region of the physical memory device having the parameters of the base model. The logical memory corresponding to the first NNM also includes pointers to the parameters which are loaded from the delta file and stored in the private region of the physical memory device.

In exemplary embodiments, when a determination is made that the model database does not include a base model that corresponds to the first NMM, the method 400 includes adding the first NNM to the model database and storing the parameters of the first NNM in a shared region of a first physical memory device in the computing system. In one embodiment, the determination that the model database does not include a base model that corresponds to the first NMM is based on a determination that the model database does not include an NNM having at least a minimum threshold similarity score with the first NNM.

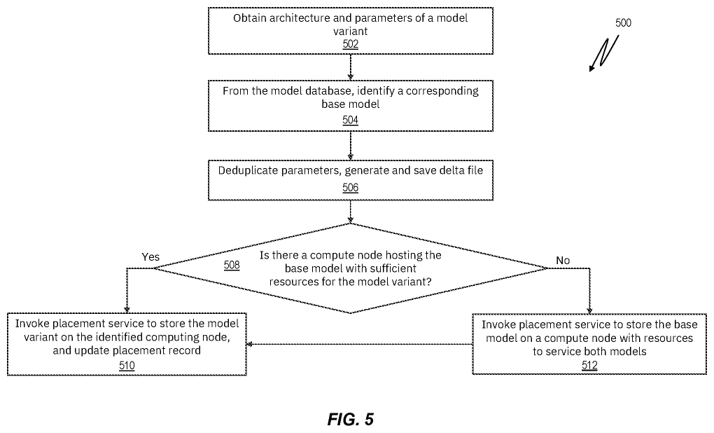

Referring now to FIG. 5, a flowchart of a method 500 for runtime sharing of a neural network model in a computing system in accordance with one or more embodiments of the present disclosure is shown. As used herein the term computing system may refer to on on-premises computing system or to a Cloud computing system that may include a public Cloud, a private could, and a combination of the two. In exemplary embodiments, the method 500 is performed by a scheduler 202, such as the one shown in FIG. 2.

As shown at block 502, the method 500 includes obtaining the architecture and parameters of a model variant to be stored in the computing system. Next, as shown at block 504, the method 500 includes identifying a base model that corresponds to the model variant from the model database. In one embodiment, the corresponding base model is identified using a graph similarity matching algorithm to compare the architecture of the variant model to the architectures of the base models stored in the model database. As shown at block 506, the method 500 also includes deduplicating the parameters of the variant model and the identified base model and saving a delta file that includes the non-duplicate parameters. In one embodiment, the delta file may include one or more non-duplicate layers of the variant model and the identified base model. In another embodiment, the delta file may include one or more difference values that indicate a difference between the values of the parameters of the variant model and the identified base model.

Next, as shown at decision block 508, the method 500 includes determining whether the computing system includes a compute node hosting the base model with sufficient resources for the model variant. Based on a determination that the computing system includes a compute node hosting the base model with sufficient resources for the model variant, the method 500 proceeds to block 510. At block 510, the method 500 includes invoking a placement service to store the model variant on the identified computing node and updating a placement record to store the location of the model variant. Based on a determination that the computing system does not include a compute node hosting the base model with sufficient resources for the model variant, the method 500 proceeds to block 512 and invokes the placement service to store the base model and the variant model on a compute node with resources to service both models.

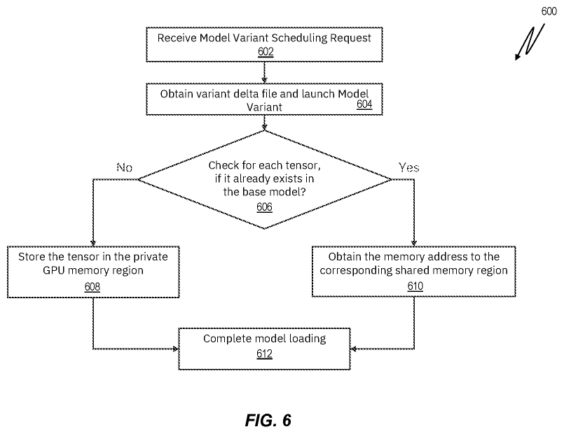

Referring now to FIG. 6, a flowchart of a method 600 for executing a neural network model in a computing system in accordance with one or more embodiments of the present disclosure is shown. In exemplary embodiments, the method 600 is performed by a scheduler 202, such as the one shown in FIG. 2.

As shown at block 602, the method 600 includes receiving a scheduling request for a model variant, i.e., a request to execute or use the model variant. Next, as shown at block 604, the method 600 includes obtaining a delta file corresponding to the model variant and launching the model variant. At decision block 606, the method 600 includes checking for each tensor, or layer of the model variant, if the tensor exists in the base model. Based on a determination that a tensor exists in the base model, the method proceeds to block 610 and obtains the memory address to the corresponding shared memory region having the tensor. Based on a determination that a tensor does not exist in the base model, the method proceeds to block 608 and stores the tensor in a private GPU memory region that corresponds to the model variant. The method 600 concludes at block 612 by completing the loading of the variant model.

In exemplary embodiments, a base model service is launched on each compute node in the computing system to serve the base model during runtime. For each base model, the service creates a shared memory region in GPU and allocates memory to the base model's tensors from this region. For PEFT, the pointers can be passed on to the other tenant containers. For full-model Fine-tuning, the service also shares base model pointers with tenant containers for them to apply the delta.

In exemplary embodiments, upon starting execution, the model serving container obtains the pointers to the shared GPU memory from the service hosted by the base model service. For PEFT, the serving runtime finds the tensors from the model variant that are common with the base model. The runtime uses the shared pointers for the common tensors, whereas the exclusive tensors are retrieved from the model scanner and load them into the private memory region in GPU. For fully fine-tuned models, the runtime retrieves the delta from the model scanner and applies (or removes) the delta to the base model during runtime as necessary.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for runtime sharing of multiple neural network models in a computing system, the method comprising:
receiving a request to store first neural network model (NNM) in the computing system;
obtaining parameters of the first NNM;
identifying a base model, from a model database, corresponding to the first NNM;
identifying duplicate parameters of the first NNM and the base model;
generating a delta file corresponding to non-duplicate parameters of the first NNM and the base model;
identifying a physical memory device in the computing system that includes a shared region that includes at least a portion of the base model; and
loading, in a private region of the physical memory device, the parameters from the delta file.

2. The computer-implemented method of claim 1, wherein the physical memory device is a graphical processing unit.

3. The computer-implemented method of claim 1, further comprising creating a logical memory corresponding to the first NNM, the logical memory including pointers to the shared region of the physical memory device having parameters of the base model and a pointer to the delta file that is stored in the private region of the physical memory device.

4. The computer-implemented method of claim 1, wherein the delta file includes one or more layers of the first NNM that are not identical to layers of the base model.

5. The computer-implemented method of claim 1, wherein the delta file includes a difference value for each of the parameters of the first NNM and the base model.

6. The computer-implemented method of claim 1, wherein the base model is identified at least based in part on calculating a similarity score of an architecture of the first NNM and the architecture of a plurality of NNMs in the model database.

7. The computer-implemented method of claim 1, wherein based on a determination that the model database does not include a NNM having at least a minimum threshold similarity score with the first NNM, the method further comprises:
adding the first NNM to the model database; and
storing the parameters of the first NNM in a shared region of a first physical memory device in the computing system.

8. A computing system having a memory having computer readable instructions and one or more processors for executing the computer readable instructions, the computer readable instructions controlling the one or more processors to perform operations comprising:
receiving a request to store first neural network model (NNM) in the computing system;
obtaining parameters of the first NNM;
identifying a base model, from a model database, corresponding to the first NNM;
identifying duplicate parameters of the first NNM and the base model;
generating a delta file corresponding to non-duplicate parameters of the first NNM and the base model;
identifying a physical memory device in the computing system that includes a shared region that includes at least a portion of the base model; and
loading, in a private region of the physical memory device, the parameters from the delta file.

9. The computing system of claim 8, wherein the physical memory device is a graphical processing unit.

10. The computing system of claim 8, wherein the operations further comprise creating a logical memory corresponding to the first NNM, the logical memory including pointers to the shared region of the physical memory device having parameters of the base model and a pointer to the delta file that is stored in the private region of the physical memory device.

11. The computing system of claim 8, wherein the delta file includes one or more layers of the first NNM that are not identical to layers of the base model.

12. The computing system of claim 8, wherein the delta file includes a difference value for each of the parameters of the first NNM and the base model.

13. The computing system of claim 8, wherein the base model is identified at least based in part on calculating a similarity score of an architecture of the first NNM and the architecture of a plurality of NNMs in the model database.

14. The computing system of claim 8, wherein based on a determination that the model database does not include a NNM having at least a minimum threshold similarity score with the first NNM, the operations further comprise:
adding the first NNM to the model database; and
storing the parameters of the first NNM in a shared region of a first physical memory device in the computing system.

15. A computer program product comprising a computer readable storage medium having program instructions embodied therewith, the program instructions executable by a processor to cause the processor to perform operations comprising:
receiving a request to store first neural network model (NNM) in a computing system;
obtaining parameters of the first NNM;
identifying a base model, from a model database, corresponding to the first NNM;
identifying duplicate parameters of the first NNM and the base model;
generating a delta file corresponding to non-duplicate parameters of the first NNM and the base model;
identifying a physical memory device in the computing system that includes a shared region that includes at least a portion of the base model; and
loading, in a private region of the physical memory device, the parameters from the delta file.

16. The computer program product of claim 15, wherein the physical memory device is a graphical processing unit.

17. The computer program product of claim 15, wherein the operations further comprise creating a logical memory corresponding to the first NNM, the logical memory including pointers to the shared region of the physical memory device having parameters of the base model and a pointer to the delta file that is stored in the private region of the physical memory device.

18. The computer program product of claim 15, wherein the delta file includes one or more layers of the first NNM that are not identical to layers of the base model.

19. The computer program product of claim 15, wherein the delta file includes a difference value for each of the parameters of the first NNM and the base model.

20. The computer program product of claim 15, wherein the base model is identified at least based in part on calculating a similarity score of an architecture of the first NNM and the architecture of a plurality of NNMs in the model database.
